(19) United States
(12) Patent Application Publication
(10) Pub. No.: US 2026/0046709 A1
(43) Pub. Date: Feb. 12, 2026

(54) ENABLING AND DISABLING DUAL STACK COMMUNICATIONS

(71) Applicant: QUALCOMM Incorporated, San Diego, CA (US)

(72) Inventors: Miguel GRIOT, La Jolla, CA (US); Gavin Bernard HORN, La Jolla, CA (US); Kianoush HOSSEINI, San Diego, CA (US); Ozcan OZTURK, San Diego, CA (US); Punyaslok PURKAYASTHA, San Diego, CA (US)

(21) Appl. No.: 18/796,159

(22) Filed: Aug. 6, 2024

(51) Int. Cl. H04W 36/00; H04W 36/06; H04W 76/20

(52) U.S. Cl. CPC H04W 36/00698; H04W 36/06; H04W 76/20

(57) ABSTRACT

Methods, systems, and devices for wireless communications are described. The described techniques may enable a network to indicate control information related to enabling or disabling a user equipment (UE) to access one or more radio access networks (RAN) simultaneously using dual stack (DS) access. For example, a UE may receive a configuration message indicating access information related to accessing a first network using a first protocol stack and accessing a second network using a second protocol stack. The control information may enable or disable the UE to access both of the first network and second network. The UE may accordingly access one or both of the first network and the second network using one or both of the first protocol stack and the second protocol stack, respectively, according to the control information.

### FIELD OF TECHNOLOGY

The following relates to wireless communications, including enabling and disabling dual stack (DS) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a configuration message indicating one or more sets of activation information for dual stack access, by the UE, of a first network associated with a first radio access technology (RAT) using a first protocol stack and of a second network associated with a second RAT using a second protocol stack, where the one or more sets of activation information instructs the UE to enable or disable dual stack (DS) access by the UE and accessing one or both of the first network and the second network using one or both of the first protocol stack and the second protocol stack, respectively, in accordance with the one or more sets of activation information.

A UE for wireless communications is described. The UE may include one or more memories storing processor executable code, and one or more processors coupled with the one or more memories. The one or more processors may individually or collectively be operable to execute the code to cause the UE to receive a configuration message indicating one or more sets of activation information for DS access, by the UE, of a first network associated with a first RAT using a first protocol stack and of a second network associated with a second RAT using a second protocol stack, where the one or more sets of activation information instructs the UE to enable or disable DS access by the UE and access one or both of the first network and the second network using one or both of the first protocol stack and the second protocol stack, respectively, in accordance with the one or more sets of activation information.

Another UE for wireless communications is described. The UE may include means for receiving a configuration message indicating one or more sets of activation information for DS access, by the UE, of a first network associated with a first RAT using a first protocol stack and of a second network associated with a second RAT using a second protocol stack, where the one or more sets of activation information instructs the UE to enable or disable DS access by the UE and means for accessing one or both of the first network and the second network using one or both of the first protocol stack and the second protocol stack, respectively, in accordance with the one or more sets of activation information.

A non-transitory computer-readable medium storing code for wireless communications is described. The code may include instructions executable by one or more processors to receive a configuration message indicating one or more sets of activation information for DS access, by the UE, of a first network associated with a first RAT using a first protocol stack and of a second network associated with a second RAT using a second protocol stack, where the one or more sets of activation information instructs the UE to enable or disable DS access by the UE and access one or both of the first network and the second network using one or both of the first protocol stack and the second protocol stack, respectively, in accordance with the one or more sets of activation information.

Some examples of the method, UEs, and non-transitory computer-readable medium described herein may further include operations, features, means, or instructions for performing a cell reselection to establish a connection with a cell based on the one or more sets of activation information instructing the UE to disable DS access by the UE.

In some examples of the method, UEs, and non-transitory computer-readable medium described herein, receiving the configuration message may include operations, features, means, or instructions for receiving a system information block (SIB) indicating the one or more sets of activation information.

In some examples of the method, UEs, and non-transitory computer-readable medium described herein, receiving the configuration message may include operations, features, means, or instructions for receiving a radio resource control (RRC) message indicating the one or more sets of activation information.

Some examples of the method, UEs, and non-transitory computer-readable medium described herein may further include operations, features, means, or instructions for transmitting a RRC reconfiguration complete message in response to the RRC message.

In some examples of the method, UEs, and non-transitory computer-readable medium described herein, the one or more sets of activation information indicate activation information for all communications by the UE, for one or more applications used by the UE, for one or more services provided to the UE, for one or more network slices, or any combination thereof.

Some examples of the method, UEs, and non-transitory computer-readable medium described herein may further include operations, features, means, or instructions for operating according to a first set of activation information of the one or more sets of activation information associated with the first protocol stack or a second set of activation information of the one or more sets of activation information associated with the second protocol stack based on a first priority associated with the first set of activation information and on a second priority associated with the second set of activation information.

Some examples of the method, UEs, and non-transitory computer-readable medium described herein may further include operations, features, means, or instructions for operating according to the one or more sets of activation information or one or more policies of the UE based on whether the one or more sets of activation information may be enabled or disabled.

Some examples of the method, UEs, and non-transitory computer-readable medium described herein may further include operations, features, means, or instructions for operating according to one or more first RRC rules associated with the first protocol stack or one or more second RRC rules associated with the second protocol stack based on a first priority associated with the one or more first RRC rules and on a second priority associated with the one or more second RRC rules.

Some examples of the method, UEs, and non-transitory computer-readable medium described herein may further include operations, features, means, or instructions for operating according to one or more RRC rules or one or more policies of the UE based on whether the one or more RRC rules may be enabled or disabled.

In some examples of the method, UEs, and non-transitory computer-readable medium described herein, the one or more sets of activation information indicate for the UE to access the first network and the second network using the first protocol stack and the second protocol stack, respectively and traffic associated with the UE may be aggregated across the first network and the second network.

In some examples of the method, UEs, and non-transitory computer-readable medium described herein, the one or more sets of activation information indicate for the UE to access the first network and the second network using the first protocol stack and the second protocol stack, respectively and traffic associated with the UE may be steered to one of the first network or the second network.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enabling and disabling dual stack (DS) communications in accordance with one or more aspects of the present disclosure.

FIG. 2 shows an example of a network architecture that supports enabling and disabling DS communications in accordance with one or more aspects of the present disclosure.

FIG. 3 shows an example of a wireless communications system that supports enabling and disabling DS communications in accordance with one or more aspects of the present disclosure.

FIG. 4 shows an example of a process flow that supports enabling and disabling DS communications in accordance with one or more aspects of the present disclosure.

FIGS. 5 and 6 show block diagrams of devices that support enabling and disabling DS communications in accordance with one or more aspects of the present disclosure.

FIG. 7 shows a block diagram of a communications manager that supports enabling and disabling DS communications in accordance with one or more aspects of the present disclosure.

FIG. 8 shows a diagram of a system including a device that supports enabling and disabling DS communications in accordance with one or more aspects of the present disclosure.

FIGS. 9 and 10 show flowcharts illustrating methods that support enabling and disabling DS communications in accordance with one or more aspects of the present disclosure.

### DETAILED DESCRIPTION

In some wireless communications systems, a user equipment (UE) may communicate with one or more networks using one or more protocol stacks. For example, the UE may communicate with a first network (e.g., a 5G radio access network (RAN) node associated with a 5G radio access technology (RAT)) using a first protocol stack (e.g., a 5G protocol stack), and may communicate with a second network (e.g., a 6G RAN node associated with a 6G RAT) using a second protocol stack (e.g., a 6G protocol stack). In some examples, a UE may communicate with multiple networks during a “migration period” in which different networks may support different RATs. Accordingly, the UE may support dual stack (DS) access, in which the UE may perform wireless communications over two networks using two protocol stacks (e.g., simultaneously or by switching between each protocol stack). DS access thereby enables communication with multiple networks using multiple protocol stacks at the same UE, allowing for deployment flexibility among networks. However, DS access may result in limited UE capabilities for communication with each network and interruptions in communications with one network as resources of the UE are used to communicate with another network. Additionally, to perform DS access, the UE may perform one or more measurements and may use transmission or reception gaps, which may decrease an efficiency of communication resource usage.

Accordingly, techniques described herein enable a network to indicate control information related to enabling or disabling a UE to access one or more additional networks. For example, a UE may receive a configuration message (e.g., a system information block (SIB) or radio resource control (RRC) message) indicating control information related to accessing a first network using a first protocol stack and accessing a second network using a second protocol stack. The control information may enable or disable the UE to access both of the first network and second network. The UE may accordingly access one or both of the first network and the second network using one or both of the first protocol stack and the second protocol stack, respectively, according to the control information. In some examples, the configuration message may enable or disable the UE to use DS access per application or service, per slice, per rule, or overall (e.g., per UE).

Aspects of the disclosure are initially described in the context of wireless communications systems. Aspects of the disclosure are further illustrated by and described with reference to process flows, apparatus diagrams, system diagrams, and flowcharts that relate to enabling and disabling DS communications.

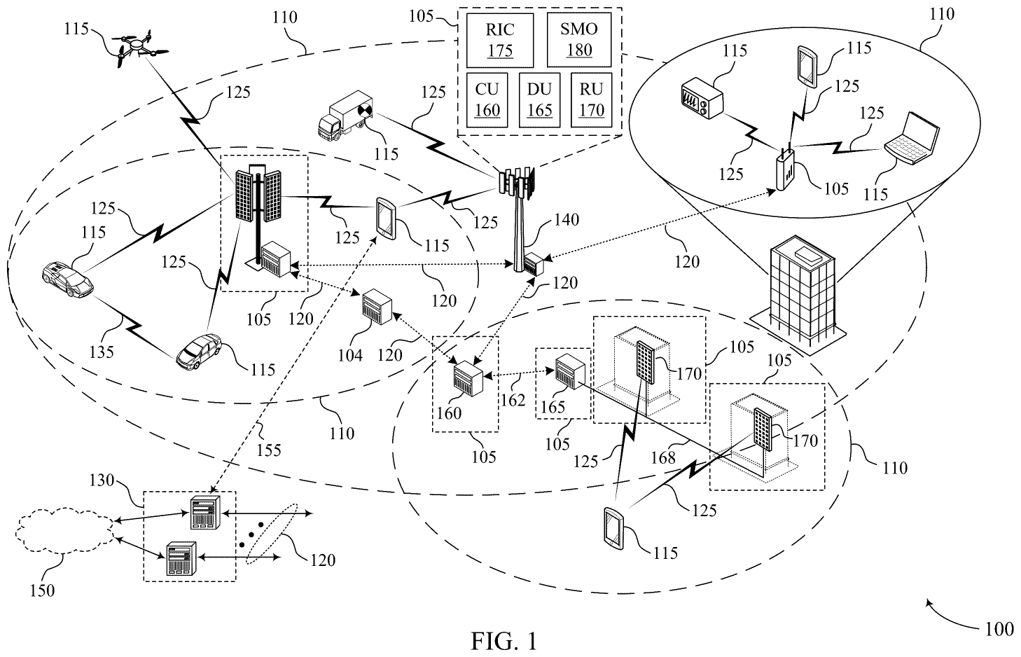

FIG. 1 shows an example of a wireless communications system 100 that supports enabling and disabling DS communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU—CP) and CU user plane (CU—UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a network entity 105 (e.g., a RAN node associated with a first network) may indicate control information related to enabling or disabling a UE 115 to simultaneously access one or more additional networks using DS access. For example, a UE 115 may receive a configuration message (e.g., a SIB or RRC message) from the network entity 105 indicating control information related to accessing the first network using a first protocol stack and accessing a second network using a second protocol stack. The control information may enable or disable the UE 115 to access both of the first network and second network. The UE 115 may accordingly access one or both of the first network and the second network using one or both of the first protocol stack and the second protocol stack, respectively, according to the control information. In some examples, the configuration message may enable or disable the UE 115 to use DS access per application or service, per slice, per rule, or overall (e.g., per UE 115). In some examples, the UE 115 may perform a cell reselection (e.g., if the network entity 105 indicates that the UE 115 may not use DS access).

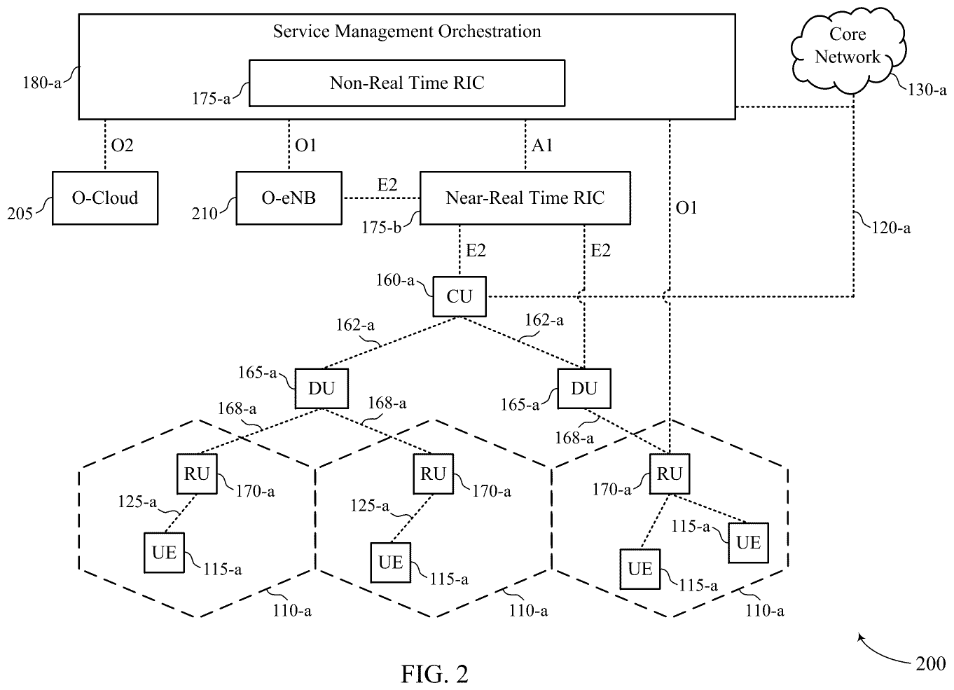

FIG. 2 shows an example of a network architecture 200 (e.g., a disaggregated base station architecture, a disaggregated RAN architecture) that supports enabling and disabling DS communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU—UP), control plane functionality (e.g., CU—CP), or a combination thereof. In some examples, a CU 160-a may be logically split into one or more CU—UP units and one or more CU—CP units. A CU—UP unit may communicate bidirectionally with the CU—CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

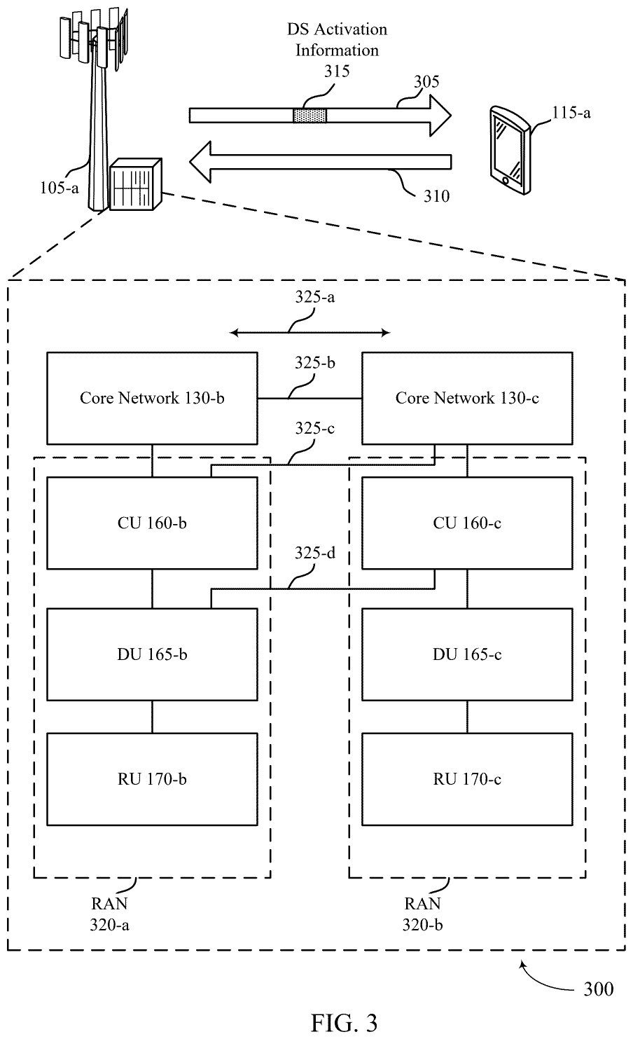

FIG. 3 shows an example of a wireless communications system 300 that supports enabling and disabling DS communications in accordance with one or more aspects of the present disclosure. The wireless communications system 300 may implement or may be implemented by aspects of the wireless communications system 100 and the network architecture 200. For example, the wireless communications system 300 may be implemented by a UE 115 (e.g., a UE 115-a) and a network entity 105 (e.g., a network entity 105-a), which may be examples of the corresponding devices as described with reference to FIG. 1.

In some examples of the wireless communication system 300, a UE 115-a may communicate with a network entity 105-a via one or more channels. For example, the UE 115-a may receive one or more downlink messages from the network entity 105-a via a downlink channel 305 and may transmit one or more uplink messages to the network entity 105-a via an uplink channel 310.

In some examples, one or more devices of the wireless communication system 300 may operate according to either or both of a first protocol stack associated with a first RAT or a second protocol stack associated with a second RAT. For example, the wireless communication system 300 may transition from the first RAT to the second RAT, and the UE 115-a may operate according to either or both of the first protocol stack or the second protocol stack during a transition period from the first RAT to the second RAT. In some examples, the UE 115-a may access a core network 130-b using the first protocol stack and a core network 130-c using the second protocol stack. The core network 130-b and the core network 130-c may be examples of different core networks associated with different registrations and different RATs.

In some examples, to enable migration from the first RAT to the second RAT, the wireless communications system 300 may support DS communications by the UE 115-b. That is, the UE 115-b may communicate with both of the core network 130-b and the core network 130-c using a respective protocol stack via a cell of the network entity 105-a. In such examples, the network entity 105-a may be an example of a RAN node associated with the second RAT (e.g., a 6G RAN node). In some examples, the first protocol stack associated with the core network 130-b may include a RAN 320-a, which may include an RU 170-b, a DU 165-b, and a CU 160-b. The protocol stack associated with the core network 130-c may include a RAN 320-b, which may include an RU 170-c, a DU 165-c, and a CU 160-c. By enabling DS communications of the UE 115-b, the wireless communications system 300 may support a relatively smoother transition between RATs than some other techniques (e.g., dual connectivity (DC), as illustrated by the traffic flow 325-d).

In some examples, to enable DS access by the UE 115-a, traffic may be aggregated across one or more protocol stacks or may be aggregated (e.g., split) or steered (e.g., switched) between each protocol stack. For example, as illustrated with reference to a traffic flow 325-b and a traffic flow 325-c, traffic from the UE 115-a may be split across or steered between various entities in each protocol stack. Additionally, or alternatively, as illustrated with reference to a traffic flow 325-a, the wireless communication system 300 may enable end-to-end (E2E) DS, in which DS communication (e.g., traffic splitting or aggregation between protocol stacks) may be integrated per-layer of each protocol stack.

In some examples, however, the cell of the network entity 105-a may not support DS communications by the UE 115-b. Additionally, or alternatively, the network entity 105-a may support DS communications for some applications, services, or network slices (e.g., Single-Network Slice Selection Assistance Information (S-NSSAI), and may not support DS communications for some applications, services, or network slices. Additionally, or alternatively, the UE 115-a may have relatively reduced capabilities when using DS communications (e.g., due to communicating using a relatively less capable RAT, such as the first RAT), and the network entity 105-a may accordingly disable DS communications by the UE 115-a. In some examples, the network entity 105-a may disable DS communications by the UE 115-a for one or more other reasons, such as a load of the network entity 105-a or the cell of the network entity 105-a (e.g., an amount of UEs 115 in communication with the network entity 105-a or an amount of traffic served by the network entity 105-a), energy efficiency considerations, and the like.

The network entity 105-a may therefore transmit a control message indicating DS activation information 315 to the UE 115-a. For example, the control message may indicate one or more sets of DS activation information 315. The DS activation information 315 may enable the network entity 105-a to advise the UE 115-a to enable or disable DS for network access. Additionally, or alternatively, the DS activation information 315 may indicate to the UE 115-a whether specific services, applications, or network slices are allowed or prevented from using DS. The UE 115-a may perform one or more operations in accordance with the DS activation information 315.

In some examples, the network entity 105-a may indicate the DS activation information 315 via a SIB (e.g., which may indicate information similar to unified access control (UAC) information). The SIB may indicate per-cell (e.g., primary cell) access rules that may apply to DS-specific access categories across one or more UEs 115 in communication with the network entity 105-a. Additionally, or alternatively, the network entity 105-a may indicate the DS activation information 315 via a RRC message (e.g., via dedicated RRC signaling, such as an RRC reconfiguration message). The RRC message may indicate DS access rules that may be specific to each UE 115, which may account for UE-specific considerations (e.g., QoS parameters and the like). The UE 115-a may transmit an RRC reconfiguration complete message in response to the RRC reconfiguration message.

In some examples, information indicated via an SIB (e.g., such as UAC information) may enable the network entity 105-a (e.g., the 6G RAN node) to control DS for all UEs 115, per service, per application, or per slice. For example, the information indicated via the SIB may be cell-specific information and may define access categories (e.g., S-NSSAI, data network name (DNN), operating system (OS) application identifier (AppID), and the like), and may provide enable or disable rules to enable or disable DS for each access category. Accordingly, as illustrated with reference to Table 1, the network entity 105-a may enable or disable DS for each access category. The described access categories may be operator-controlled access categories.

TABLE 1

| | Access Category | | |
|---|---|---|---|
| Rule | DS Capable UE | Application/Service | Slice (S-NSSAI) |
| Enable DS | UE may access the | UE may access the cell and | UE may access the |
| | cell and use for DS | enable DS for a given | cell and enable DS |
| | | application or service | for a given slice |
| Disable | UE may not access | UE may not offer the given | UE may not use DS |
| DS | the cell and use for | application or service DS | feature for the given |
| | DS | feature | slice |

In some examples, the UE 115-a may perform one or more operations in response to receiving the SIB indicating the DS access rules for each access category. For example, if the DS activation information 315 indicates that the UE 115-a may enable DS (e.g., for all communications by the UE 115-a, for a given application or service used by the UE 115-a, or for a network slice used by the UE 115-a), the UE 115-a may use DS communications for the enabled access categories.

Additionally, or alternatively, if the DS activation information 315 indicates for the UE 115-a to disable DS communications (e.g., all DS communications by the UE 115-a), the UE 115-a may disable DS and access the cell of the network entity 105-a without DS, or may reselect to another cell that may enable DS communications. If the DS activation information 315 indicates for the UE 115-a to disable DS communications for a given application or service, the UE 115-a may disable DS for the given application or service, or may reselect to another cell that may enable DS communications for the given application or service. If the DS activation information 315 indicates for the UE 115-a to disable DS communications for a given network slice, the UE 115-a may disable DS for the given network slice, reselect to another cell that may enable DS communications for the given network slice, or may connect to the network via a slice for which DS is enabled in the cell of the network entity 105-a (e.g., if policies enable the UE 115-a to switch to a different network slice).

In some examples, information indicated via an RRC message may enable the network entity 105-a (e.g., the 6G RAN node) to control DS per UE 115, per service, per application, or per slice. For example, the information indicated via the SIB may be UE-specific information and may define RRC rule categories (e.g., S-NSSAI, DNN, OS AppID, and the like), and may provide enable or disable rules to enable or disable DS for each rule category. Accordingly, as illustrated with reference to Table 2, the network entity 105-a may enable or disable DS for each rule category. The network entity 105-a may accordingly determine, on a UE-specific basis, which UEs 115, applications, services, and network slices the network entity 105-a may enable or disable DS communications for.

TABLE 2

| | Rule Category | | |
|---|---|---|---|
| Rule | UE Rule | Application/Service | Slice (S-NSSAI) |
| Enable DS | UE can use DS | UE can use DS according to | UE can use DS |
| | according to UE | UE policies for a given | according to UE |
| | policies | application or service | policies for a given |
| | | | slice |
| Disable | DS is disables for | DS is disables for UE for | DS is disables for UE |
| DS | UE until enabled by | the given | for the given slice |
| | reconfiguration | application/service until | until enabled by |
| | | enabled by reconfiguration | reconfiguration |

In some examples, the UE 115-a may perform one or more operations in response to receiving the RRC message indicating the DS access rules for each rule category. For example, if the DS activation information 315 indicates that the UE 115-a may enable DS (e.g., for all communications by the UE 115-a, for a given application or service used by the UE 115-a, or for a network slice used by the UE 115-a), the UE 115-a may use DS communications for the enabled rule categories according to UE policies.

Additionally, or alternatively, if the DS activation information 315 indicates for the UE 115-a to disable DS communications (e.g., all DS communications by the UE 115-a), the UE 115-a may disable DS and access the cell of the network entity 105-a without DS until DS is enabled by an additional RRC reconfiguration message. For example, the UE 115-a may receive a second RRC reconfiguration message indicating an additional one or more sets of DS activation information 315, which may indicate that the UE 115-a may enable DS. If the DS activation information 315 indicates for the UE 115-a to disable DS communications for a given application or service, the UE 115-a may disable DS for the given application or service until DS is enabled for the given application or service by an additional RRC reconfiguration message. If the DS activation information 315 indicates for the UE 115-a to disable DS communications for a given network slice, the UE 115-a may disable DS for the given network slice until DS is enabled for the given network slice by an additional RRC reconfiguration message, or may connect to the network via a slice for which DS is enabled in the cell of the network entity 105-a (e.g., if policies such as UE route selection policies (URSP) enable the UE 115-a to switch to a different network slice).

In some examples, one or more rules indicated by the SIB (e.g., UAC rules, the one or more sets of DS activation information 315, or both) may be conflicting. In such examples, the UE 115-a may determine which rule the UE 115-a may operate (e.g., communicate via the uplink channel 310 and the downlink channel 305) according to based on a priority associated with each rule. For example, each entry in a list of rules (e.g., each UAC rule in a UAC list, each set of DS activation information 315) may be associated with a priority. If the UE 115-a identifies that one or more of the rules conflict, the UE 115-a may operate according to the rule of the one or more conflicting rules with a higher priority.

In some examples, one or more rules indicated by the SIB (e.g., UAC rules, the one or more sets of DS activation information 315, or both) may conflict with one or more policies of the UE 115-a. In such examples, the UE 115-a may determine whether to operate (e.g., communicate via the uplink channel 310 and the downlink channel 305) according to the one or more rules or to the one or more policies of the UE 115-a based on whether the one or more rules (e.g., the UAC rules, the one or more sets of DS activation information 315, or both) are enabled or disabled. For example, if the DS activation information 315 indicates that DS is enabled (e.g., for the cell, for the UE 115-a, for one or more applications, for one or more services, or for one or more network slices), the UE 115-a may operate according to the one or more policies of the UE 115-a. If the DS activation information 315 indicates that DS is disabled (e.g., for the cell, for the UE 115-a, for one or more applications, for one or more services, or for one or more network slices), the UE 115-a may operate according to the DS activation information 315.

In some examples, one or more rules indicated by the RRC message (e.g., RRC rules, the one or more sets of DS activation information 315, or both) may be conflicting. For example, a first set of DS activation information 315 may indicate that DS is enabled for an application, and a second set of DS activation information 315 may indicate that DS is disabled for a network slice. In such examples, the UE 115-a may determine which rule the UE 115-a may operate (e.g., communicate via the uplink channel 310 and the downlink channel 305) according to based on a priority associated with each rule. For example, each entry in a list of rules (e.g., each RRC rule in the RRC message, each set of DS activation information 315) may be associated with a priority. If the UE 115-a identifies that one or more of the rules conflict, the UE 115-a may operate according to the rule of the one or more conflicting rules with a higher priority.

In some examples, one or more rules indicated by the RRC message (e.g., RRC rules, the one or more sets of DS activation information 315, or both) may conflict with one or more policies of the UE 115-a. In such examples, the UE 115-a may determine whether to operate (e.g., communicate via the uplink channel 310 and the downlink channel 305) according to the one or more rules or to the one or more policies of the UE 115-a based on whether the one or more rules (e.g., the RRC rules, the one or more sets of DS activation information 315, or both) are enabled or disabled. For example, if the DS activation information 315 indicates that DS is enabled (e.g., for the cell, for the UE 115-a, for one or more applications, for one or more services, or for one or more network slices), the UE 115-a may operate according to the one or more policies of the UE 115-a. If the DS activation information 315 indicates that DS is disabled (e.g., for the cell, for the UE 115-a, for one or more applications, for one or more services, or for one or more network slices), the UE 115-a may operate according to the DS activation information 315.

In some examples, the DS activation information 315 may indicate one or more DS modes (e.g., when DS is enabled for the cell, for the UE 115-a, for one or more applications, for one or more services, or for one or more network slices). For example, if the DS activation information 315 indicates that DS is enabled, the DS activation information 315 may indicate an enabled DS mode. In some examples, the DS activation information 315 may indicate an enabled DS mode for the UE 115-a, for the cell, for each application for which DS is enabled, for each service for which DS is enabled, or for each network slice for which DS is enabled.

In some examples, the DS modes may include an aggregation mode (e.g., splitting) and a steering mode (e.g., switching). For example, if the DS activation information 315 indicates that DS aggregation is enabled, the UE 115-a may aggregate traffic or split traffic across each protocol stack. That is, the DS activation information 315 may indicate one or more applications, services, or slices for which traffic may be aggregated or split between each access. If the DS activation information 315 indicates that DS steering is enabled, the UE 115-a may steer traffic or switch traffic across each protocol stack. That is, the DS activation information 315 may indicate one or more applications, services, or slices for which traffic may be steered over one of the accesses.

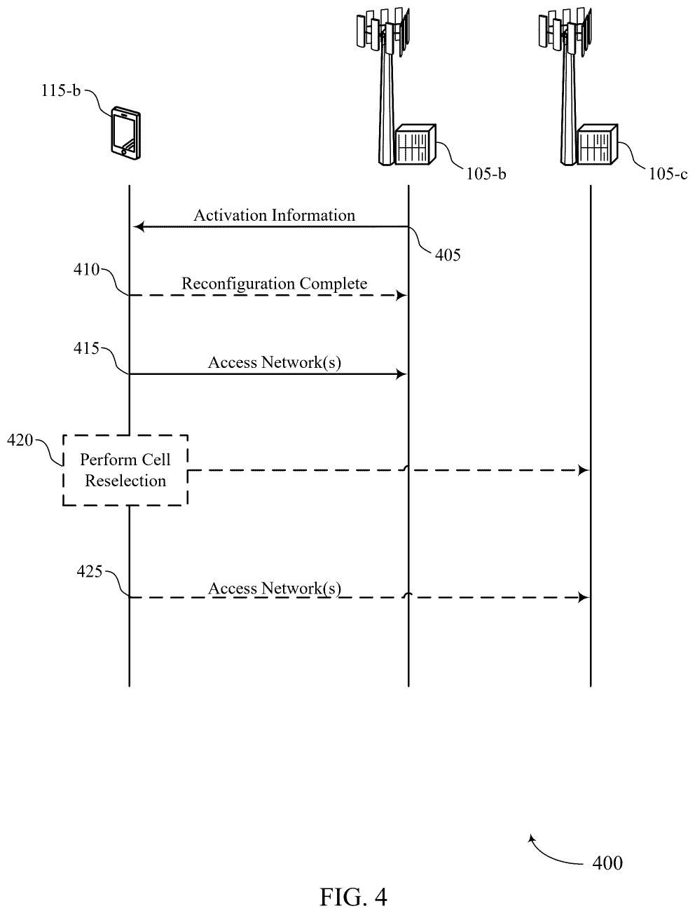

FIG. 4 shows an example of a process flow 400 that supports enabling and disabling DS communications in accordance with one or more aspects of the present disclosure. The process flow 400 may implement or may be implemented by aspects of the wireless communications system 100, the network architecture 200, and the wireless communications system 300. For example, the process flow 400 may be implemented by a UE 115 (e.g., a UE 115-b) and one or more network entities 105 (e.g., a network entity 105-b, a network entity 105-c), which may be examples of the corresponding devices as described with reference to FIG. 1. In some examples, the network entity 105-b and the network entity 105-c may be examples of RAN nodes that are associated with one or more RATs.

In the following description of the process flow 400, the operations between the UE 115-b, the network entity 105-b, and the network entity 105-c may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the network entity 105-b may transmit, to the UE 115-b, a configuration message indicating one or more sets of activation information for DS access. For example, the activation information may indicate whether the UE 115-b may access a first RAT using a first protocol stack and a second RAT using a second protocol stack. The configuration message may be an RRC message (e.g., an RRC reconfiguration message) or a SIB. In some examples, at 410, the UE 115-b may transmit an RRC reconfiguration complete message in response to receiving the configuration message (e.g., if the configuration message is an RRC message).

In some examples, the one or more sets of activation information may indicate activation information for all communications by the UE 115-b, for one or more applications used by the UE, for one or more services provided to the UE, or for one or more network slices. In some examples, the one or more sets of activation information may indicate for the UE to access the first network and the second network using the first protocol stack and the second protocol stack, respectively, by aggregating traffic associated with the UE across the first network and the second network or by steering traffic associated with the UE to one of the first network and the second network.

At 415, the UE 115-b may access one or both of the first network and the second network (e.g., via the network entity 105-b) using one or both of the first protocol stack and the second protocol stack, respectively. For example, the UE 115-b may access one or more applications, services, network slices, and the like using one or both of the first network and the second network as indicated by the one or more sets of activation information. As an illustrative example, if a first set of activation information indicates for the UE 115-b to enable DS for a first application and to disable DS for a second application, the UE 115-b may access the first application using both of the first network and the second network and may access the second application using one of the first network or the second network.

For example, to access one or both of the first network and the second network, the UE 115-b may operate according to a first set of activation information of the one or more sets of activation information (e.g., a first set of activation information associated with the first protocol stack) or according to a second set of activation information of the one or more sets of activation information (e.g., a second set of activation information associated with the second protocol stack) based at least in part on a first priority associated with the first set of activation information and on a second priority associated with the second set of activation information. For example, the UE 115-b may operate according to a set of activation information with a higher priority.

In some examples, to access one or both of the first network and the second network, the UE 115-b may operate according to the one or more sets of activation information or one or more policies of the UE based at least in part on whether the one or more sets of activation information are enabled or disabled. In some examples, to access one or both of the first network and the second network, the UE 115-b may operate according to one or more first RRC rules (e.g., with a first priority) associated with the first protocol stack or one or more second RRC rules (e.g., with a second priority) associated with the second protocol stack based on the first priority and on the second priority. In some examples, to access one or both of the first network and the second network, the UE 115-b may operate according to one or more RRC rules or one or more policies of the UE based at least in part on whether the one or more RRC rules are enabled or disabled.

In some examples, at 420, the UE 115-b may perform a cell reselection to reselect to a cell of a network entity 105-c. For example, the UE 115-b may perform the cell reselection in response to the one or more sets of activation information from the network entity 105-b indicating for the UE 115-b to disable DS. In such examples, the UE 115-b may perform the cell reselection to reselect to a cell that may enable DS.

In such examples, at 425, the UE 115-b may access one or both of the first network and the second network via the network entity 105-c using one or both of the first protocol stack and the second protocol stack, respectively. For example, the UE 115-b may operate as described with reference to step 415.

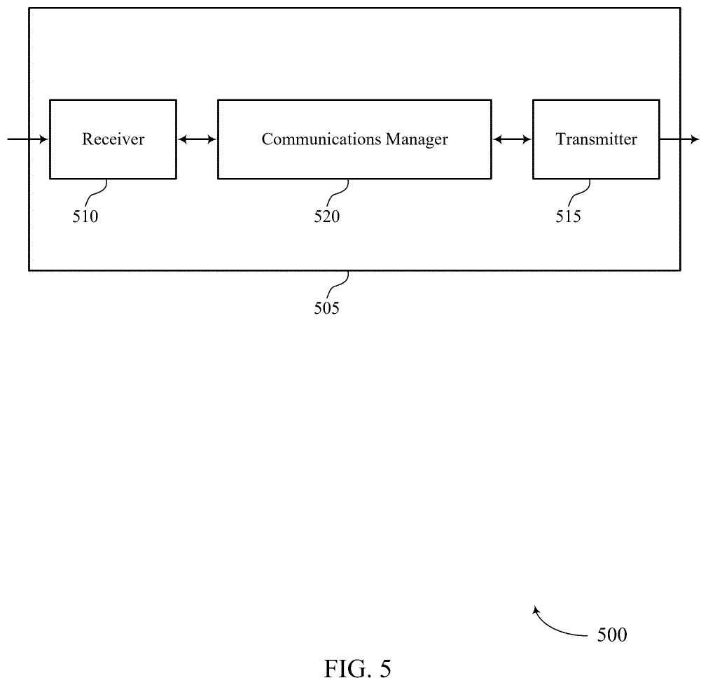

FIG. 5 shows a block diagram 500 of a device 505 that supports enabling and disabling DS communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enabling and disabling DS communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enabling and disabling DS communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of enabling and disabling DS communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The communications manager 520 is capable of, configured to, or operable to support a means for accessing one or both of the first network and the second network using one or both of the first protocol stack and the second protocol stack, respectively, in accordance with the one or more sets of activation information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for enabling a UE to communicate using DS access, which may result in more efficient utilization of communication resources as a result of communicating via multiple RATs.

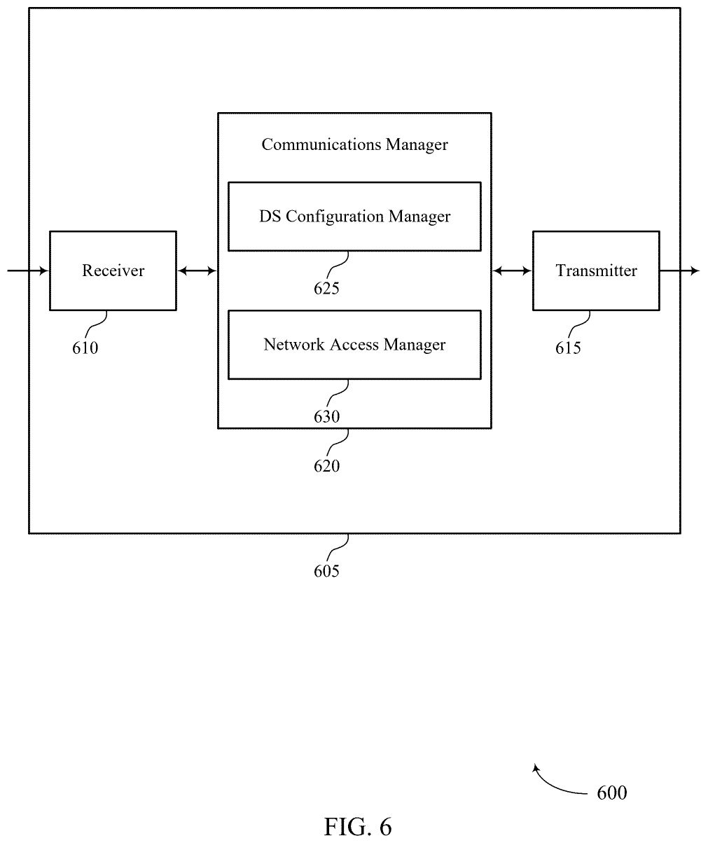

FIG. 6 shows a block diagram 600 of a device 605 that supports enabling and disabling DS communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enabling and disabling DS communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enabling and disabling DS communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enabling and disabling DS communications as described herein. For example, the communications manager 620 may include a DS configuration manager 625 a network access manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The DS configuration manager 625 is capable of, configured to, or operable to support a means for receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The network access manager 630 is capable of, configured to, or operable to support a means for accessing one or both of the first network and the second network using one or both of the first protocol stack and the second protocol stack, respectively, in accordance with the one or more sets of activation information.

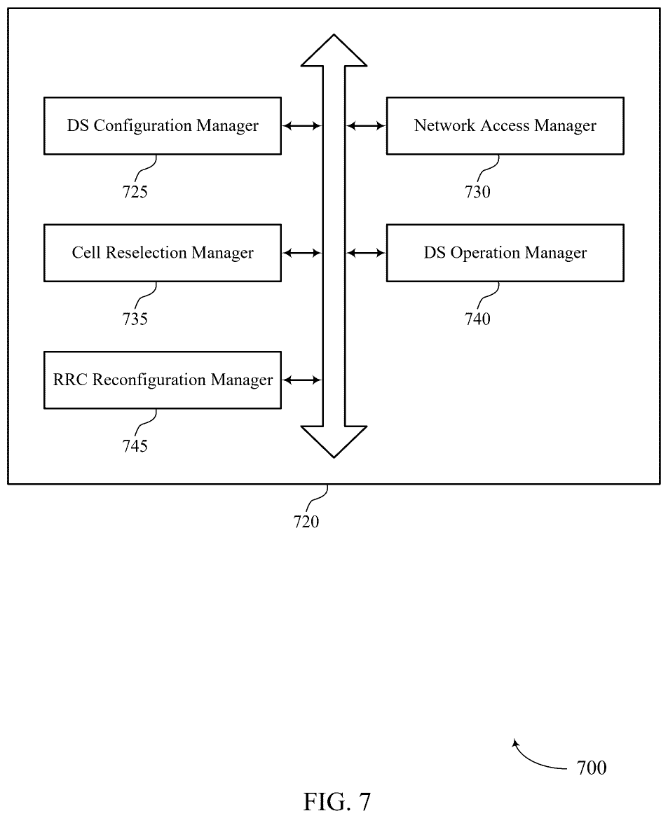

FIG. 7 shows a block diagram 700 of a communications manager 720 that supports enabling and disabling DS communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enabling and disabling DS communications as described herein. For example, the communications manager 720 may include a DS configuration manager 725, a network access manager 730, a cell reselection manager 735, a DS operation manager 740, an RRC reconfiguration manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The DS configuration manager 725 is capable of, configured to, or operable to support a means for receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The network access manager 730 is capable of, configured to, or operable to support a means for accessing one or both of the first network and the second network using one or both of the first protocol stack and the second protocol stack, respectively, in accordance with the one or more sets of activation information.

In some examples, the cell reselection manager 735 is capable of, configured to, or operable to support a means for performing a cell reselection to establish a connection with a cell based at least in part on the one or more sets of activation information instructing the UE to disable DS access by the UE.

In some examples, to support receiving the configuration message, the DS configuration manager 725 is capable of, configured to, or operable to support a means for receiving a SIB indicating the one or more sets of activation information.

In some examples, to support receiving the configuration message, the DS configuration manager 725 is capable of, configured to, or operable to support a means for receiving a radio resource control message indicating the one or more sets of activation information.

In some examples, the RRC reconfiguration manager 745 is capable of, configured to, or operable to support a means for transmitting a radio resource control reconfiguration complete message in response to the radio resource control message.

In some examples, the one or more sets of activation information indicate activation information for all communications by the UE, for one or more applications used by the UE, for one or more services provided to the UE, for one or more network slices, or any combination thereof.

In some examples, the DS operation manager 740 is capable of, configured to, or operable to support a means for operating according to a first set of activation information of the one or more sets of activation information associated with the first protocol stack or a second set of activation information of the one or more sets of activation information associated with the second protocol stack based at least in part on a first priority associated with the first set of activation information and on a second priority associated with the second set of activation information.

In some examples, the DS operation manager 740 is capable of, configured to, or operable to support a means for operating according to the one or more sets of activation information or one or more policies of the UE based at least in part on whether the one or more sets of activation information are enabled or disabled.

In some examples, the DS operation manager 740 is capable of, configured to, or operable to support a means for operating according to one or more first RRC rules associated with the first protocol stack or one or more second RRC rules associated with the second protocol stack based at least in part on a first priority associated with the one or more first RRC rules and on a second priority associated with the one or more second RRC rules.

In some examples, the DS operation manager 740 is capable of, configured to, or operable to support a means for operating according to one or more RRC rules or one or more policies of the UE based at least in part on whether the one or more RRC rules are enabled or disabled.

In some examples, the one or more sets of activation information indicate for the UE to access the first network and the second network using the first protocol stack and the second protocol stack, respectively. In some examples, traffic associated with the UE is aggregated across the first network and the second network.

In some examples, the one or more sets of activation information indicate for the UE to access the first network and the second network using the first protocol stack and the second protocol stack, respectively. In some examples, traffic associated with the UE is steered to one of the first network or the second network.

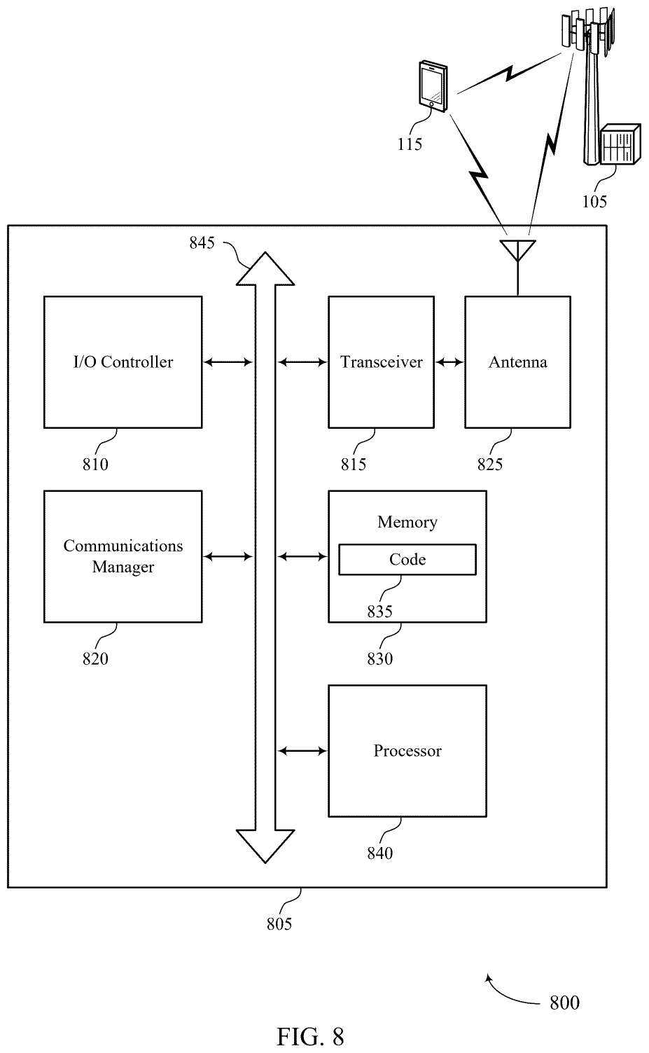

FIG. 8 shows a diagram of a system 800 including a device 805 that supports enabling and disabling DS communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting enabling and disabling DS communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The communications manager 820 is capable of, configured to, or operable to support a means for accessing one or both of the first network and the second network using one or both of the first protocol stack and the second protocol stack, respectively, in accordance with the one or more sets of activation information.

By including or configuring the communications manager 820 in accordance with examples as described herein, the device 805 may support techniques for enabling a UE to communicate using DS access, which may result in improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of enabling and disabling DS communications as described herein, or the at least one processor 840 and the at least one memory 830 may be otherwise configured to, individually or collectively, perform or support such operations.

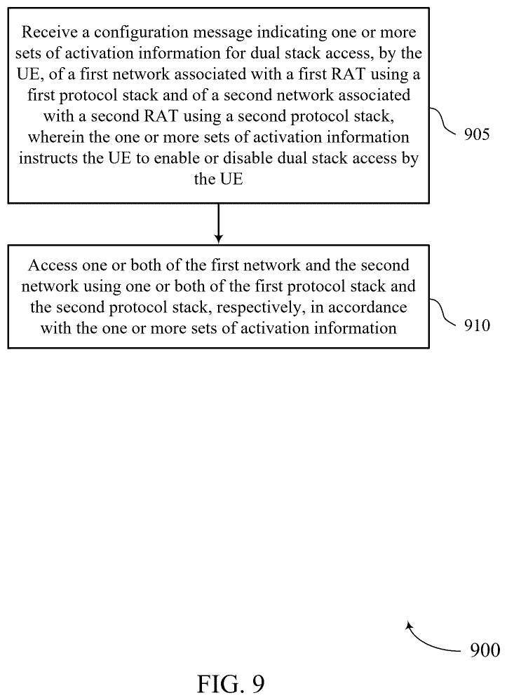

FIG. 9 shows a flowchart illustrating a method 900 that supports enabling and disabling DS communications in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The operations of 905 may be performed in accordance with examples as disclosed herein. In some examples, aspects of the operations of 905 may be performed by a DS configuration manager 725 as described with reference to FIG. 7.

At 910, the method may include accessing one or both of the first network and the second network using one or both of the first protocol stack and the second protocol stack, respectively, in accordance with the one or more sets of activation information. The operations of 910 may be performed in accordance with examples as disclosed herein. In some examples, aspects of the operations of 910 may be performed by a network access manager 730 as described with reference to FIG. 7.

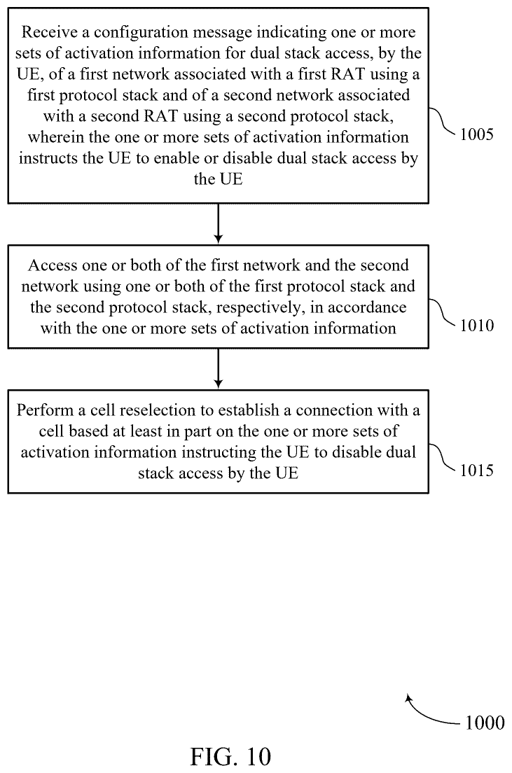

FIG. 10 shows a flowchart illustrating a method 1000 that supports enabling and disabling DS communications in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE. The operations of 1005 may be performed in accordance with examples as disclosed herein. In some examples, aspects of the operations of 1005 may be performed by a DS configuration manager 725 as described with reference to FIG. 7.

At 1010, the method may include accessing one or both of the first network and the second network using one or both of the first protocol stack and the second protocol stack, respectively, in accordance with the one or more sets of activation information. The operations of 1010 may be performed in accordance with examples as disclosed herein. In some examples, aspects of the operations of 1010 may be performed by a network access manager 730 as described with reference to FIG. 7.

At 1015, the method may include performing a cell reselection to establish a connection with a cell based at least in part on the one or more sets of activation information instructing the UE to disable DS access by the UE. The operations of 1015 may be performed in accordance with examples as disclosed herein. In some examples, aspects of the operations of 1015 may be performed by a cell reselection manager 735 as described with reference to FIG. 7.

The following provides an overview of aspects of the present disclosure:

Aspect 1: A method for wireless communications by a UE, comprising: receiving a configuration message indicating one or more sets of activation information for DS access, by the UE, of a first network associated with a first RAT using a first protocol stack and of a second network associated with a second RAT using a second protocol stack, wherein the one or more sets of activation information instructs the UE to enable or disable DS access by the UE; and accessing one or both of the first network and the second network using one or both of the first protocol stack and the second protocol stack, respectively, in accordance with the one or more sets of activation information.

Aspect 2: The method of aspect 1, further comprising: performing a cell reselection to establish a connection with a cell based at least in part on the one or more sets of activation information instructing the UE to disable DS access by the UE.

Aspect 3: The method of any of aspects 1 through 2, wherein receiving the configuration message comprises: receiving a SIB indicating the one or more sets of activation information.

Aspect 4: The method of any of aspects 1 through 2, wherein receiving the configuration message comprises: receiving a RRC message indicating the one or more sets of activation information.

Aspect 5: The method of aspect 4, further comprising: transmitting a RRC reconfiguration complete message in response to the RRC message.

Aspect 6: The method of any of aspects 1 through 5, wherein the one or more sets of activation information indicate activation information for all communications by the UE, for one or more applications used by the UE, for one or more services provided to the UE, for one or more network slices, or any combination thereof.

Aspect 7: The method of any of aspects 1 through 6, further comprising: operating according to a first set of activation information of the one or more sets of activation information associated with the first protocol stack or a second set of activation information of the one or more sets of activation information associated with the second protocol stack based at least in part on a first priority associated with the first set of activation information and on a second priority associated with the second set of activation information.

Aspect 8: The method of any of aspects 1 through 7, further comprising: operating according to the one or more sets of activation information or one or more policies of the UE based at least in part on whether the one or more sets of activation information are enabled or disabled.

Aspect 9: The method of any of aspects 1 through 8, further comprising: operating according to one or more first RRC rules associated with the first protocol stack or one or more second RRC rules associated with the second protocol stack based at least in part on a first priority associated with the one or more first RRC rules and on a second priority associated with the one or more second RRC rules.

Aspect 10: The method of any of aspects 1 through 9, further comprising: operating according to one or more RRC rules or one or more policies of the UE based at least in part on whether the one or more RRC rules are enabled or disabled.

Aspect 11: The method of any of aspects 1 through 10, wherein the one or more sets of activation information indicate for the UE to access the first network and the second network using the first protocol stack and the second protocol stack, respectively, and wherein traffic associated with the UE is aggregated across the first network and the second network.

Aspect 12: The method of any of aspects 1 through 11, wherein the one or more sets of activation information indicate for the UE to access the first network and the second network using the first protocol stack and the second protocol stack, respectively, and wherein traffic associated with the UE is steered to one of the first network or the second network.

Aspect 13: A UE for wireless communications, comprising one or more memories storing processor-executable code, and one or more processors coupled with the one or more memories and individually or collectively operable to execute the code to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a configuration message indicating one or more sets of activation information for dual stack access, by the UE, of a first network associated with a first radio access technology (RAT) using a first protocol stack and of a second network associated with a second RAT using a second protocol stack, wherein the one or more sets of activation information instructs the UE to enable or disable dual stack access by the UE; and
access one or both of the first network and the second network using one or both of the first protocol stack and the second protocol stack, respectively, in accordance with the one or more sets of activation information.

2. The UE of claim 1, wherein the one or more processors are individually or collectively further operable to execute the code to cause the UE to:
perform a cell reselection to establish a connection with a cell based at least in part on the one or more sets of activation information instructing the UE to disable dual stack access by the UE.

3. The UE of claim 1, wherein, to receive the configuration message, the one or more processors are individually or collectively operable to execute the code to cause the UE to:
receive a system information block indicating the one or more sets of activation information.

4. The UE of claim 1, wherein, to receive the configuration message, the one or more processors are individually or collectively operable to execute the code to cause the UE to:
receive a radio resource control message indicating the one or more sets of activation information.

5. The UE of claim 4, wherein the one or more processors are individually or collectively further operable to execute the code to cause the UE to:
transmit a radio resource control reconfiguration complete message in response to the radio resource control message.

6. The UE of claim 1, wherein the one or more sets of activation information indicate activation information for all communications by the UE, for one or more applications used by the UE, for one or more services provided to the UE, for one or more network slices, or any combination thereof.

7. The UE of claim 1, wherein the one or more processors are individually or collectively further operable to execute the code to cause the UE to:
operate according to a first set of activation information of the one or more sets of activation information associated with the first protocol stack or a second set of activation information of the one or more sets of activation information associated with the second protocol stack based at least in part on a first priority associated with the first set of activation information and on a second priority associated with the second set of activation information.

8. The UE of claim 1, wherein the one or more processors are individually or collectively further operable to execute the code to cause the UE to:
operate according to the one or more sets of activation information or one or more policies of the UE based at least in part on whether the one or more sets of activation information are enabled or disabled.

9. The UE of claim 1, wherein the one or more processors are individually or collectively further operable to execute the code to cause the UE to:
operate according to one or more first radio resource control rules associated with the first protocol stack or one or more second radio resource control rules associated with the second protocol stack based at least in part on a first priority associated with the one or more first radio resource control rules and on a second priority associated with the one or more second radio resource control rules.

10. The UE of claim 1, wherein the one or more processors are individually or collectively further operable to execute the code to cause the UE to:
operate according to one or more radio resource control rules or one or more policies of the UE based at least in part on whether the one or more radio resource control rules are enabled or disabled.

11. The UE of claim 1, wherein the one or more sets of activation information indicate for the UE to access the first network and the second network using the first protocol stack and the second protocol stack, respectively, wherein traffic associated with the UE is aggregated across the first network and the second network.

12. The UE of claim 1, wherein the one or more sets of activation information indicate for the UE to access the first network and the second network using the first protocol stack and the second protocol stack, respectively, wherein traffic associated with the UE is steered to one of the first network or the second network.

13. A method for wireless communications by a user equipment (UE), comprising:
receiving a configuration message indicating one or more sets of activation information for dual stack access, by the UE, of a first network associated with a first radio access technology (RAT) using a first protocol stack and of a second network associated with a second RAT using a second protocol stack, wherein the one or more sets of activation information instructs the UE to enable or disable dual stack access by the UE; and
accessing one or both of the first network and the second network using one or both of the first protocol stack and the second protocol stack, respectively, in accordance with the one or more sets of activation information.

14. The method of claim 13, further comprising:
performing a cell reselection to establish a connection with a cell based at least in part on the one or more sets of activation information instructing the UE to disable dual stack access by the UE.

15. The method of claim 13, wherein receiving the configuration message comprises:
receiving a system information block indicating the one or more sets of activation information.

16. The method of claim 13, wherein receiving the configuration message comprises:
receiving a radio resource control message indicating the one or more sets of activation information.

17. The method of claim 16, further comprising:
transmitting a radio resource control reconfiguration complete message in response to the radio resource control message.

18. The method of claim 13, wherein the one or more sets of activation information indicate activation information for all communications by the UE, for one or more applications used by the UE, for one or more services provided to the UE, for one or more network slices, or any combination thereof.

19. The method of claim 13, further comprising:
operating according to a first set of activation information of the one or more sets of activation information associated with the first protocol stack or a second set of activation information of the one or more sets of activation information associated with the second protocol stack based at least in part on a first priority associated with the first set of activation information and on a second priority associated with the second set of activation information.

20. A non-transitory computer-readable medium storing code for wireless communications, the code comprising instructions executable by one or more processors to:
receive a configuration message indicating one or more sets of activation information for dual stack access, by a user equipment (UE), of a first network associated with a first radio access technology (RAT) using a first protocol stack and of a second network associated with a second RAT using a second protocol stack, wherein the one or more sets of activation information instructs the UE to enable or disable dual stack access by the UE; and
access one or both of the first network and the second network using one or both of the first protocol stack and the second protocol stack, respectively, in accordance with the one or more sets of activation information.
